(19) United States
(12) Patent Application Publication
(10) Pub. No.: US 2009/0114161 A1
(43) Pub. Date: May 7, 2009

(54) Disposable animal waste collecting pad and reciever

(76) Inventors: Paul Carnahan, Sierra Vista, AZ (US); Kristy L. Carnahan, Sierra Vista, AZ (US)

Correspondence Address: REISING, ETHINGTON, BARNES, KISSELLE, P.C., P O BOX 4390, TROY, MI, 48099-4390, US

(21) Appl. No.: 11/982,926

(22) Filed: Nov. 6, 2007

(51) Int. Cl. A01K 29/00

(52) U.S. Cl. 119/169

(57) ABSTRACT

A disposable animal waste collecting receiver may include a backing sheet, an absorbent sheet, and a flexible wall. The backing sheet may be composed of a flaccid and fluid impervious material. The absorbent sheet may be layered onto the backing sheet and is for soaking-up moisture in the animal waste product. The flexible wall may be lined around the periphery of the animal waste collecting receiver and is movable between an open position, where the flexible wall has an accordion-like fold, and a closed position, where the animal waste collecting receiver can be bundled to confine the animal waste product.

### TECHNICAL FIELD

The field of this invention relates generally to receivers for collecting pet animal waste product, and more specifically to such animal waste collecting pads and receivers designed for effective and easy disposal.

### BACKGROUND OF THE DISCLOSURE

Disposable animal waste collecting receivers, sometimes referred to as pads, are commonly placed on a floor surface of a home, dwelling, or place for pets to relieve themselves, for disposal of excrement and urine from dogs, cats, and other pets after use. Oftentimes, animal waste product can spill out of the animal waste collecting receiver when closing it, throwing it away, or both. What is therefore needed is a disposable animal waste collecting receiver that reduces the chances of or altogether prevents animal waste product from spilling out of the receiver.

### SUMMARY OF THE DISCLOSURE

One embodiment of a disposable animal waste collecting receiver may include a backing sheet, an absorbent sheet, and a flexible wall. The backing sheet may be made of a flaccid and fluid impervious material. The absorbent sheet may be layered on top of the backing sheet and is for soaking-up moisture in the animal waste product that is received on the absorbent sheet. The flexible wall may be lined around the periphery of the animal waste collecting receiver and can be moved between an open position, where the flexible wall has an accordion-like fold, and a closed position, where the animal waste collecting receiver is bundled to confine the animal waste product.

One embodiment of a method of forming a disposable animal waste collecting receiver may include providing a backing sheet, providing an absorbent sheet, lining a flexible wall, and folding the flexible wall. The backing sheet may be made of a flaccid and fluid impervious material. The absorbent sheet may be layered on top of the backing sheet and is for soaking-up moisture in the animal waste product that is received on the absorbent sheet. The flexible wall may be lined to the periphery of the backing sheet. And the flexible wall may be folded to an accordion-like fold to form a plurality of folds one-on-top-of-the-other in a zigzag relationship.

One embodiment of a disposable animal waste collecting receiver that can be used on a floor surface may include a backing sheet, an absorbent sheet, a flexible wall, and a drawstring. The backing sheet may be made of a flaccid and fluid impervious material and may constitute the bottommost layer of the animal waste collecting receiver. The absorbent sheet may be layered on top of the backing sheet and is for soaking-up moisture in the animal waste product, and may constitute the uppermost layer of the animal waste collecting receiver. The flexible wall may be lined around and may extend from the periphery of the backing sheet. The flexible wall can be moved from an open position, where the flexible wall has an accordion-like fold forming a plurality of folds in a zigzag relationship to be substantially flat with respect to the floor surface, to a closed position, where the animal waste collecting receiver is bundled to confine the animal waste. The flexible wall may have a peripheral mouth that defines a continuous channel. The drawstring may be held in the channel for drawing the peripheral mouth closed and thus the flexible wall to the closed position.

### BRIEF DESCRIPTION OF THE DRAWINGS

Reference now is made to the accompanying drawings in which:

FIG. 1 is a perspective view of one embodiment of a disposable animal waste collecting receiver in an open position, showing a flexible wall with its vertical height exaggerated for illustrative purposes;

FIG. 2 is a sectional view of the disposable animal waste collecting receiver taken along line 2-2 in FIG. 1; and

FIG. 3 is a side view showing the disposable animal waste collecting receiver of FIG. 1 in a closed position.

### DETAILED DESCRIPTION OF THE PREFERRED EMBODIMENTS

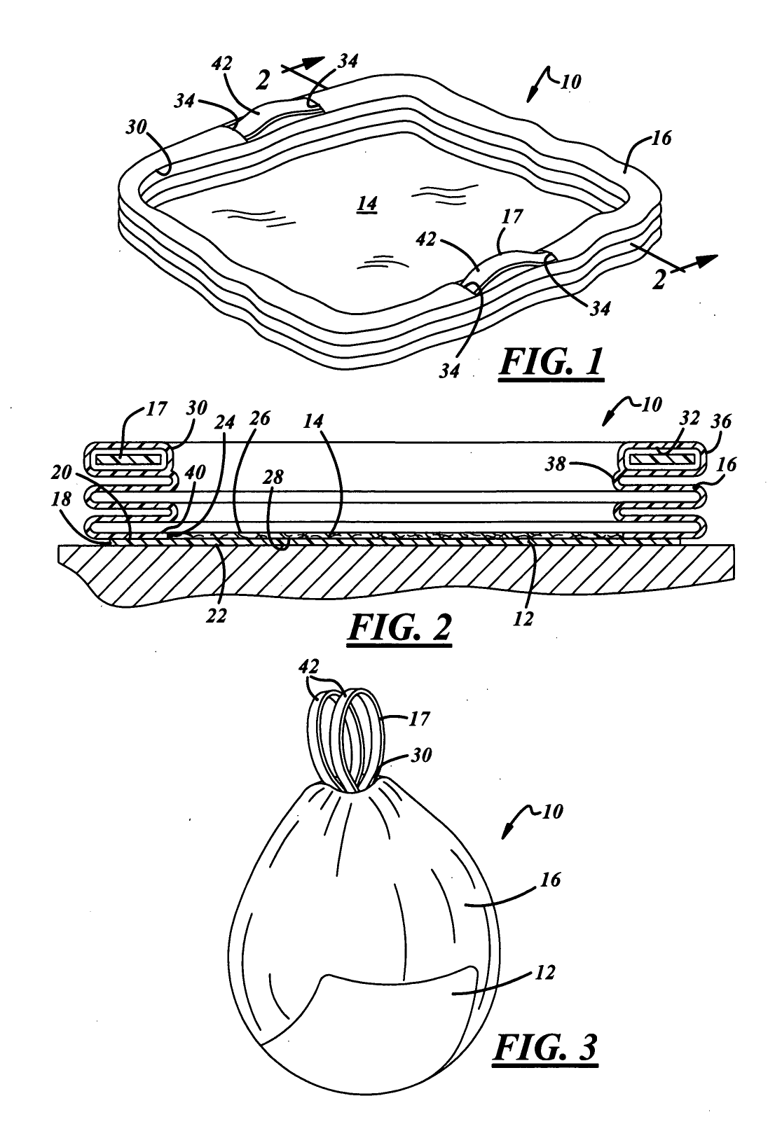

Referring now to the drawings, FIGS. 1-3 show one example embodiment of a disposable animal waste collecting receiver or pad 10 that can confine pet animal waste product, and that can then be closed and thrown-away effectively while minimizing or altogether preventing the product from spilling out of the receiver. Particularly, the animal waste collecting receiver 10 can be put to use in an open position, where it is substantially flat on a floor surface of a home, dwelling, or the like to receive animal waste product, and can then be bundled to a closed position to confine the product and be thrown-away. Referring to FIG. 1, the animal waste collecting receiver 10 may take a generally rectangular shape with rounded corners, or can have other shapes including rectangular with sharp corners, circular, or the like. The animal waste collecting receiver 10 may include a backing sheet 12, an absorbent sheet 14, a flexible wall 16, and a drawstring 17. The wall 16 when full collapsed can also be flat e.g. less than 1 mm thick about the periphery depend on the thickness of the wall material.

Referring to FIG. 2, the backing sheet 12 prevents animal waste product from leaking through the animal waste collecting receiver 10 to the floor surface. The backing sheet 12 may constitute the bottommost layer of the animal waste collecting receiver 10 and is thus laid against and contacts the floor surface; or in other embodiments an additional sheet may be layered beneath the backing sheet to constitute the bottommost layer. The backing sheet 12 may be made of a flaccid and fluid impervious material such as polyethylene, polypropylene, or other materials known to skilled artisans. The backing sheet 12 has a periphery 18 which defines the outer boundary of the backing sheet and is thus shaped similarly to the animal waste collecting receiver 10. In this example embodiment, the absorbent sheet 14 and the flexible wall 16 are adhered to a top surface 20 of the backing sheet 12, and a bottom surface 22 of the backing sheet 12 rests on the ground surface when the animal waste collecting receiver 10 is poised to receive animal waste product.

Referring to FIGS. 1 and 2, the absorbent sheet 14 soaks up moisture, such as urine and other semi-liquid or semi-solid material, present in the animal waste product that is received and contacts the absorbent sheet. In other words, the absorbent sheet 14 draws in and holds liquid and other matter that would otherwise puddle on a nonabsorbing surface. The absorbent sheet 14 may be layered on top of the backing sheet 12 and attached thereto in a number of ways including gluing, adhesion, stitching, stapling, or the like known to skilled artisans. The absorbent sheet 14 may constitute the uppermost surface of the animal waste collecting receiver 10 when it is poised to receive animal waste product. The absorbent sheet 14 may be made of a number of absorbent materials including a fibrous pad, a crepe paper, wood fluff, disposable cloth, or other suitable materials known to skilled artisans. A periphery 24 defines an outer boundary of the absorbent sheet 14 and may be similarly shaped to the backing sheet 12 and can, but need not, extend as far outward as the periphery 18. A top surface 26 of the absorbent sheet 14 may be exposed directly to the animal waste product and a bottom surface 28 may face and be adhered to the top surface 20 of the backing sheet 12.

Referring to FIGS. 2 and 3, the flexible wall 16 is used to confine animal waste product that falls into the animal waste collecting receiver 10 when the receiver is poised to accept animal waste product, and is also used to bundle the animal waste collecting receiver and throw it away. Put differently, the flexible wall 16 acts as an enclosure for the animal waste collecting receiver 10. In the example embodiment shown, the flexible wall 16 may be lined around and attached to the periphery 18 of the backing sheet 12. In particular, the flexible wall 16 may be attached to the top surface 20 of the backing sheet 12 at the periphery 18 by any number of ways including gluing, adhesion, stitching, stapling, or the like as known to skilled artisans. In other embodiments, the flexible wall 16 may be integral with the backing sheet 12 such that the two can be formed together. The flexible wall 16 may be made of a flexible and fluid impervious material such as a plastic like low density polyethylene (LDPE), high density polyethylene (HDPE), biodegradable polythene, or other suitable material known to skilled artisans. A peripheral mouth 30 may define an upper edge or upper boundary of the flexible wall 16, and itself may define a channel 32 hollowed substantially continuously around the peripheral mouth 30. Four slits 34 may be cut into the otherwise enclosed channel 32 as shown in FIG. 1. The flexible wall 16 has an outer surface 36 and an inner surface 38 that may be exposed to the animal waste product. A bottom edge 40 defines a bottom boundary of the flexible wall 16 that may be attached to the top surface 20 of the backing sheet 12.

The drawstring 17 can be used to draw the peripheral mouth 30 closed tight, thus closing the flexible wall 16 and the animal waste collecting receiver 10. In particular, the drawstring 17 can be cinched and tied to collapse the peripheral mouth 30 and close it. Referring to FIG. 2, the drawstring 17 may be disposed and held in the channel 32 of the flexible wall 16. The drawstring 17 may resemble an endless rope or loop and may be made of a plastic strong enough to be pulled and tied without breaking such as low density polyethylene (LDPE), high density polyethylene (HDPE), a biodegradable polythene, or other suitable material known to skilled artisans. FIGS. 1 and 3 show the drawstring 17 exposed out of the channel 32 and particularly out of the splits 34 to form a pair of opposing handles 42 for gripping the drawstring. In other embodiments not shown, a single handle may be used, or more than two handles may be used for gripping.

In use, the animal waste collecting receiver 10 confines animal waste product, and then can be closed to be thrown-away. In particular, the animal waste collecting receiver 10 may be moved from an open position (FIGS. 1 and 2) where it is poised to accept animal waste product, to a closed position (FIG. 3) where the animal waste collecting receiver is bundled and is ready to be thrown-away. Referring to FIGS. 1 and 2, in the open position the backing sheet 12 may lay generally flush against the associated floor surface, and the absorbent sheet 14 may be completely exposed and ready to accept animal waste product. The flexible wall 16 may be flattened by an accordion-like fold so that it is substantially flush with respect to the floor surface and the backing and absorbing sheets 12, 14. The accordion-like fold refers to the way that the flexible wall 16 is compressed and can be described as a number of individual fold sections with one section on-top-of-the-other in a continuous zigzag relationship. This way the flexible wall 16 is compacted in an efficient and effective way toward the floor surface without interfering with or obstructing the exposed absorbent sheet 14, or interfering with the pet using the animal waste collecting receiver 10.

Referring to FIG. 3, in the closed position the backing sheet 12 can be lifted off of the floor surface, and the absorbent sheet 14 is no longer exposed and instead is substantially enclosed by the flexible wall 16. The flexible wall 16 itself unfolds above the backing and absorbing sheets 12, 14 and expands around the animal waste product held therein as the handles 42 are gripped to draw the drawstring 17 tight around the peripheral mouth 30 to close the mouth and thus bring the animal waste collecting receiver to the closed position. The handles 42 can then be tied and the animal waste collecting receiver 10 can be thrown away.

Of course other embodiments exist that have not been shown or described. For example, the animal waste collecting receiver may include more sheets layered thereto to strengthen the animal waste collecting receiver and thus hold more animal waste product. Also, the flexible wall may span continuously beneath the backing sheet to thus constitute the bottommost surface of the animal waste collecting receiver where it would be adhered to the bottom surface of the backing sheet and function as an additional layer of leak protection.

Variations and modifications are possible without departing from the scope and spirit of the present invention as defined by the appended claims.

The embodiments in which an exclusive property or privilege is claimed are defined as follows:

1. A disposable animal waste collecting receiver comprising:
a backing sheet composed of a flaccid and fluid impervious material;
an absorbent sheet layered on top of the backing sheet for soaking-up moisture in the animal waste product that is received on the absorbent sheet; and
a flexible wall lined around the periphery of the animal waste collecting receiver and movable between an open position, where the flexible wall has an accordion-like fold, and a closed position, where the animal waste collecting receiver is bundled to confine the animal waste product.

2. The disposable animal waste collecting receiver of claim 1 wherein the backing sheet constitutes the bottommost layer of the animal waste collecting receiver to be laid against a floor surface when the flexible wall is in the open position.

3. The disposable animal waste collecting receiver of claim 1 wherein the absorbent sheet constitutes the uppermost layer of the animal waste collecting receiver to be directly exposed to animal waste product when the flexible wall is in the open position.

4. The disposable animal waste collecting receiver of claim 1 further comprising a drawstring with at least one exposed handle to draw the flexible wall to the closed position.

5. The disposable animal waste collecting receiver of claim 4 wherein the flexible wall has a peripheral mouth that defines a continuous channel, and the drawstring is an endless loop held in the channel and exposed out of the channel through opposing slits to form a pair of handles that can be gripped to draw the peripheral mouth closed and the flexible wall to the closed position.

6. The disposable animal waste collecting receiver of claim 1 wherein the flexible wall is lined around and extends from the periphery of the backing sheet.

7. The disposable animal waste collecting receiver of claim 1 wherein, when the flexible wall is in the open position, the flexible wall is substantially flat with respect to the backing sheet and absorbent sheet, and with respect to a floor surface beneath the backing sheet.

8. The disposable animal waste collecting receiver of claim 1 wherein, when the flexible wall is in the open position, the flexible wall with the accordion-like fold forms a plurality of folds one-on-top-of-the-other in a zigzag relationship.

9. A method of forming a disposable animal waste collecting receiver comprising:
providing a backing sheet composed of a flaccid and fluid impervious material;
providing an absorbent sheet layered on top of the backing sheet for soaking-up moisture in the animal waste product that is received on the absorbent sheet;
lining the periphery of the backing sheet with a flexible wall; and
folding the flexible wall to an accordion-like fold to form a plurality of folds one-on-top-of-the-other in a zigzag relationship.

10. The method of claim 9 further comprising:
defining a continuous channel in a peripheral mouth of the flexible wall; and
providing a drawstring held in the channel for drawing the flexible wall to a closed position.

11. A disposable animal waste collecting receiver and pad for use on a floor surface, the animal waste collecting receiver comprising:
a backing sheet composed of a flaccid and fluid impervious material, the backing sheet constituting the bottommost layer of the animal waste collecting receiver to be laid against the floor surface;
an absorbent sheet layered on top of the backing sheet for soaking-up moisture in the animal waste product received thereon, the absorbent sheet constituting the uppermost layer of the animal waste collecting receiver to be directly exposed to animal waste product;
a flexible wall lined around and extending from the periphery of the backing sheet and movable between an open position, where the flexible wall has an accordion-like fold forming a plurality of folds one-on-top-of-the-other in a zigzag relationship and being substantially flat with respect to the floor surface, and a closed position, where the animal waste collecting receiver is bundled to confine the animal waste product, the flexible wall having a peripheral mouth that defines a continuous channel; and
a drawstring held in the channel for drawing the peripheral mouth closed and the flexible wall to the closed position.
